(19) United States
(12) Patent Application Publication
(10) Pub. No.: US 2005/0279377 A1
(43) Pub. Date: Dec. 22, 2005

(54) Dental flossing agents, methods of use and manufacture

(76) Inventor: Peter T. Sarjeant, Highlands, NC (US)

Correspondence Address: PETER T. SARJEANT, 114 TALLEY ROAD, P.O. BOX 212, HIGHLANDS, NC, 28741, US

(21) Appl. No.: 10/868,002

(22) Filed: Jun. 16, 2004

(51) Int. Cl. A61C 15/00

(52) U.S. Cl. 132/321

(57) ABSTRACT

Improved dental flossing agents are provided that include two, three or more separated strands of typical multifilament yarns derived from PTFE, polyester, nylon, cotton or other commonly used fibers or mixtures thereof, to be cinched or conjoined at one or both ends by plaiting, knotting, or by adhesive, heat sealing, clamping or otherwise, and of a suitable length of approximately fifteen inches, severed from a roll or bobbin storage, including the selection of strands exhibiting different properties as to texture, abrasion, pharmaceutical activity or flavor and accepting of colour; with the flossing step including the conventional approach, the spreading of the separated strands for entry into two or more teeth crevices at the same time with conjoined ends readily insertable between teeth and above or below bridges or tooth appliances to effect cleaning action and all suitable for economical manufacture and distribution.

### FIELD OF INVENTION

This invention relates to improvements in dental care and more particularly to a flossing agent, a method for producing same and a procedure for cleaning the teeth that, in use, achieves a more effective removal from those crevices between the teeth, from the tooth surfaces and the gum line, of food particles, plaque deposits and the like than heretofore; with the procedure for utilizing same, working to reduce or lower the time taken to floss the teeth with the aim of accomplishing a more thorough cleansing and so better preserving the health of the teeth, gums and mouth and improved teeth polishing.

### BACKGROUND TO THE INVENTION

Dental disease is caused by bacteria harbored in plaque deposits on tooth surfaces from food particles lodged between teeth and below the gums. Regular removal of plaque and particles of food is strongly advocated as a preventative step to lower the probability of contracting dental caries and gingival infection. Since conventional brushing of the teeth has been perceived to be inadequate other processes including pulsed water irrigation, mini-brush action and dental flossing agents have been introduced and strongly recommended by dentists, with several alternatives having been in use for many years and which alternatives continue to be developed and promoted.

Curtis et al, in U.S. Pat. No. 5,209,251 and published U.S. Patent Application No. U.S. 2001/0029962 among other prior patents and applications reveal that conventional dental flossing agents can be derived from a suitable relatively small diameter, single elongated strand or monofilament; or from a tape design as disclosed in U.S. Pat. No. 4,776,358, and in U.S. Pat. No. 6,607,000 B2.

U.S. Pat. No. 6,123,982 outlines a proposal for making a dental flossing agent from texturized yarn which, during use, expands to a relatively thick cross section.

With a conventional single strand flossing agent a threading device may be required for insertion between the teeth or for application to a bridge appliance and to the gum-line to permit the flossing action especially on the gum portion adjacent the appliance.

In use, as commonly practised, a single strand or filament is inserted sequentially into tooth crevices, and reciprocated against the tooth surfaces down to the gum line. This step may leave some food particles or adhered plaque behind since the single strand or filament tends to slide around the particle and plaque when displaced towards the gum line. When withdrawn, the single strand or filament again may slide around a particle or plaque and fail to dislodge same. Thus a potential infection site is established and presents an obstacle to clear passage of other food particles, and so increase buildup of plaque.

Greater efficiency in the step of dental flossing is advocated by providing enlarged cross sections at intervals along the length of the strand or filament as outlined in U.S. Pat. No. 6,112,753.

Instruments or applicators for tensioning strands or filaments for better control of insertion, abrasion of tooth surfaces and removal of debris appear in U.S. Pat. No. 5,113,880 as well as in published U.S. patent application No. 2003/0140937 A1.

It has also been proposed to mount separated strands or filaments in an extended frame or applicator so as to effect entry into several crevices or tooth separations at the same time as described in U.S. Pat. No. 5,692,531, which details providing tensioned spaced apart strands or monofilaments in a frame of a shape adapted for full insertion into the mouth.

Another such example appears in pending U.S. application No. 2003/0140937 A1, published Jul. 31, 2003.

With such frames or applicators and tensioned strands of multiple-strung strands or filaments difficulty may be encountered in correctly orienting the frame or applicator to the tooth arrangement as well as insuring full penetration into each crevice as well as limiting the displacement of the stroke imparted to the strands or filaments; and not readily accommodating a bridge appliance nor embracing, surrounding or conforming to tooth surfaces so as to more fully contact, engage, abrade and displace the debris from the teeth crevices and surfaces.

It will be understood that by applying greater force of contact to the tooth surfaces through an abrading surrounding or encircling strand or filament and at the same time applying a cleaning agent and/or a mouth refreshing component a more effective and pleasing result can be achieved, which frame or applicator with tensioned strands or filaments are not suited to accomplish.

### OBJECTS OF THE INVENTION

Improved dental flossing agents and practices are welcome, particularly those that promote efficiency of particle and plaque removal and a higher quality performance as to surface cleaning and polishing all within a time comparable to current practice with flossing agents.

The practice of flossing teeth is well established and a preferred prophylaxis in dental care, with dentists urging patients to floss after each meal and/or before bedtime. Accordingly, in furtherance of that objective, it is intended by this invention to provide improved structures for dental flossing agents and a procedure for the application of same to the teeth that clearly advances the steps of removing food particles from tooth crevices and plaque from tooth surfaces above and below the gums and the abrading and polishing of same which reinforces and promotes flossing as a preferred choice for dental care.

It is also an object in providing several alternative structures for use as flossing agents to attract more attention to and use of same in relation to particular problem teeth or with appliances or otherwise, some of which may have more appeal to a particular individual than others.

It is also an object to provide alternative dental floss structures that are well suited for efficient production, distribution, sale and dispensing of same.

### FEATURES OF THE INVENTION

The improved flossing agents according to the invention are comprised of two or more separated strands or filaments derived from polyethylene, PTFE, polyester, nylon, cotton or other textile fibers or mixtures thereof, each selected strand or filament of a specified suitable length and paired, tripled or quadrupled to be cinched or gripped at the ends thereof in the first embodiment or conjoined at one or both ends in a second embodiment and including an embodiment in which the strands or monofilaments are joined between the opposed ends to create an enlargement to sweep any accumulation from the site.

The multi-stranded dental flossing agent or unit so structured has the capability, where more than one strand is inserted into one crevice between teeth of grasping food particles in a double, triple or quadruple grip, and thereby act to loosen them more quickly and effectively and with greater latitude at each pass of the strands over the surfaces of opposed teeth than with a single strand.

It is also to be understood that with separated strands or filaments more than one crevice can be entered at the same time so that the task becomes more efficient with the conformity of the strands or filaments to the tooth surfaces enhanced.

It is also a feature to include strands of differing properties in the improved flossing agent or unit which together can apply an abrasive force with a flavouring taste sensation, or in addition or alternatively deliver a pharmaceutical or mouthwash component or a whitener; and with colouring related to the property applied to each different strand identify or signify such property and thereby convey to the user at each cleaning the beneficent effects to be derived from such arrangement and serve as an aid in promoting the selection of same by retail purchasers.

It is also a feature of this invention in the case of multi-stranded flossing agents or units to produce extended lengths of the grouped strands or filaments conjoined at selected intervals therealong, whereby segments or units with free ends conjoined at one end only, or with two conjoined ends or segments conjoined centrally can be severed from such extended lengths to suit the choice of the user in the manipulation of same within the tooth crevices.

It will be readily appreciated that with this proposal, apart from cinching or gripping the ends of the multiple strands or filaments, several alternatives for production are available to effect interconnection or conjoinment of the several strands or filaments at intervals such as through an applied wrap or tube of suitable material, by adhesives, by heat sealing of the selected strands or filaments, or by the plaiting or knotting of strands or filaments where the triple strand or filament alternative is produced or by a winding of same or otherwise.

Moreover, such extended lengths for connection or conjoinment at intervals are readily packaged on rolls or bobbins for dispensing and that severance of selected lengths can be effected by knife edges suitably mounted in the packages.

In the case of plaited, knotted, wound or wrapped ends of the multi stranded agents or units, the junctures or conjoinment thereof being somewhat enlarged and more stiff and unyielding if inserted between teeth and adjacent a gum line will achieve greater purchase against lodged particles and thereby better insure their removal.

To use the new flossing system and to enable realization of the benefits, one holds the ends between the fingers of opposed hands to achieve reasonable tautness as is usually done. Then the strands are entered between two or more teeth depending upon the number of strands and using a continuing reciprocating action force the taut strands to conform to tooth surfaces and toward the gum-line and reversely. This action preferably is repeated for all tooth crevices.

In one application of the improved flossing agent if a food particle should be sensed between two teeth at least two strands of the flossing agent can be introduced into the crevice and tautly held, the reciprocating flossing action commenced. The separated tautly held strands so entered and reciprocated to abrade the surfaces tend to embrace the particles or debris and grip or seize same so that when the flossing agent is withdrawn the particles or debris are more readily cleared from the crevice.

When separated strands enter opposed crevices of a tooth and pulled in tautness and reciprocated two loops are presented inwardly and outwardly of the tooth which loops alternately diminish and extend and are forced to conform to the contours of the contained tooth and so exert increased abrasive forces.

The improved dental flossing agents or units by reason of the binding, plaiting, knotting, adhering and clamping of the ends to conjoin same confers a certain stiffness in that region. The stiffened cinched or conjoined ends of the improved flossing agent or unit can be readily inserted between the gum-line and a dental appliance or bridge, and the ends then grasped with the fingers and by reciprocation the flossing step is implemented.

It is also a feature of this invention in the manufacture or production of the novel flossing agents or units to serially connect the separated strands at suitably spaced apart intervals of the order of one inch in extent by heat sealing or adhering same or by knotting, or plaiting, or by a winding or by clamping same together at a station in the progress of the double or triple or more strands drawn from spools or other sources and after treatment wound on spools for use in dispensing hand-held flossing agents from packages or containers.

These and other objects and features will appear from the following description to be read in conjunction with the sheets of drawings in which:

### DRAWINGS

FIGS. 1A and 1B illustrate a first embodiment of a segment or length of a dental floss agent embodying the invention utilizing two strands or filaments conjoined at selected intervals, to be severed, at intervals so as to leave the strands or filaments at one end free for gripping FIGS. 1C and 1D illustrate a second embodiment of a segment or length similar to that depicted in FIGS. 1A and 1B doubly cinched or conjoined at selected separated intervals to be severed at intervals so as to provide strands or filaments with both ends attached.

FIGS. 2A, 2B, 2C, 2D, 2E and 2F each illustrate a third embodiment of an improved dental floss segment or length utilizing three strands or filaments cinched or conjoined at both ends to be severed at invervals so as to leave the three strands or filaments free at one end for gripping.

FIGS. 3A, 3B, 3C, 3D, 3E and 3F illustrate still another embodiment of segments or lengths similar to that shown in FIGS. 2A to 2F but doubly conjoined at both ends to be severed at intervals to provide strands or filaments with both ends attached.

FIGS. 4A, 4B, 4C, 4D, 4E, & 4F show enlargements of the several alternatives for cinching or conjoinment of dental floss agents or units utilizing three strands or filaments.

FIGS. 5A and 5B each depict one manner of use of the dental floss segment of FIGS. 1A and 1B and FIGS. 1C and 1D;

FIGS. 6A and 6B each illustrate another manner of use of the dental floss segments of FIGS. 2A to 2F and FIGS. 3A to 3F.

FIG. 7 illustrates still another embodiment of the character of the multiple strand or filament dental flossing agent corresponding to FIG. 3B in which the strands are conjoined intermediately of the ends thereof.

### DESCRIPTION

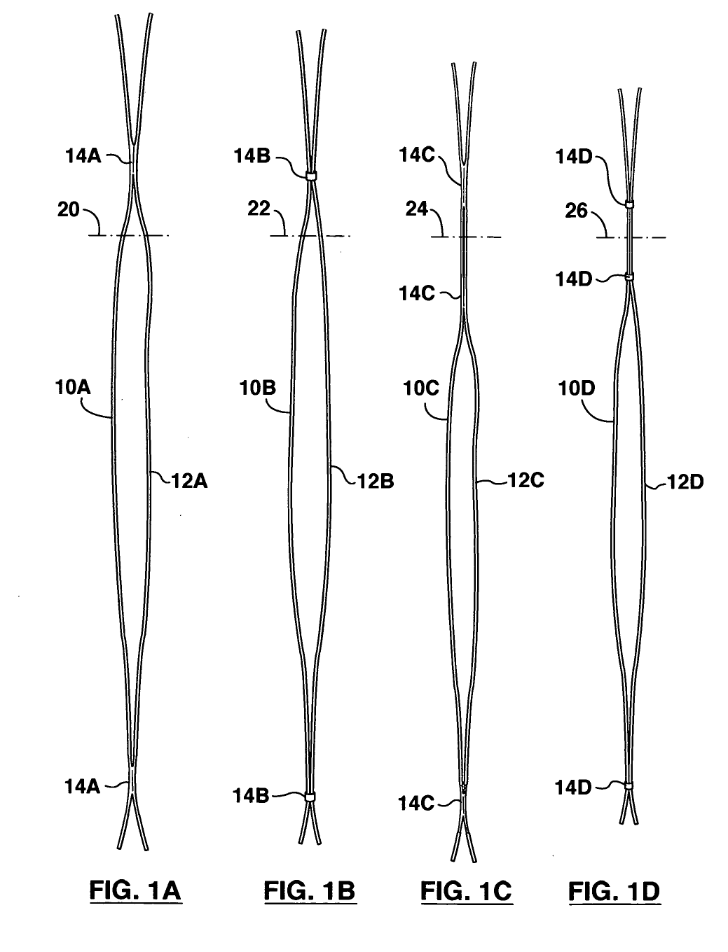

The dental floss structure embodying the invention illustrated in FIGS. 1A, 1B, 1C and 1D include separated strands 10A, 12A, 10B, 12B, 10C, 12C and 10D, 12D derived from available monofilaments or multifilament yarns derived from polyethylene, PTFE, polyester, nylon, cotton or other suitable fibers or mixtures thereof, each pair of strands 10A, 12A, 10B, 12B, 10C, 12C and 10D, 12D interconnected at both ends as indicated at 14A, 14B, 14C and 14D, respectively and each of a suitable length interval of approximately 15 inches.

The interconnection or joinder of strands 10A, 12A and 10C, 12C of FIGS. 1A and 1C as at 14A, 14C respectively is achieved by suitable adhesives or by heat sealing depending upon the characteristics of the selected strands themselves.

Individual strands or filaments for improved flossing agents or units embodying the invention should be in a range of between 500 and 1400 Dtex (that is for each 10,000 meters of filament, the weight should lie between 500 g and 1400 g.).

As described in Finklestein et al, U.S. Pat. No. 4,583,564, individual strands may be unwaxed, using a high melting point core material composed of nylon, and a low melting point sheath material such as polypropylene with the melting point of the sheath material 100 degrees less than the core.

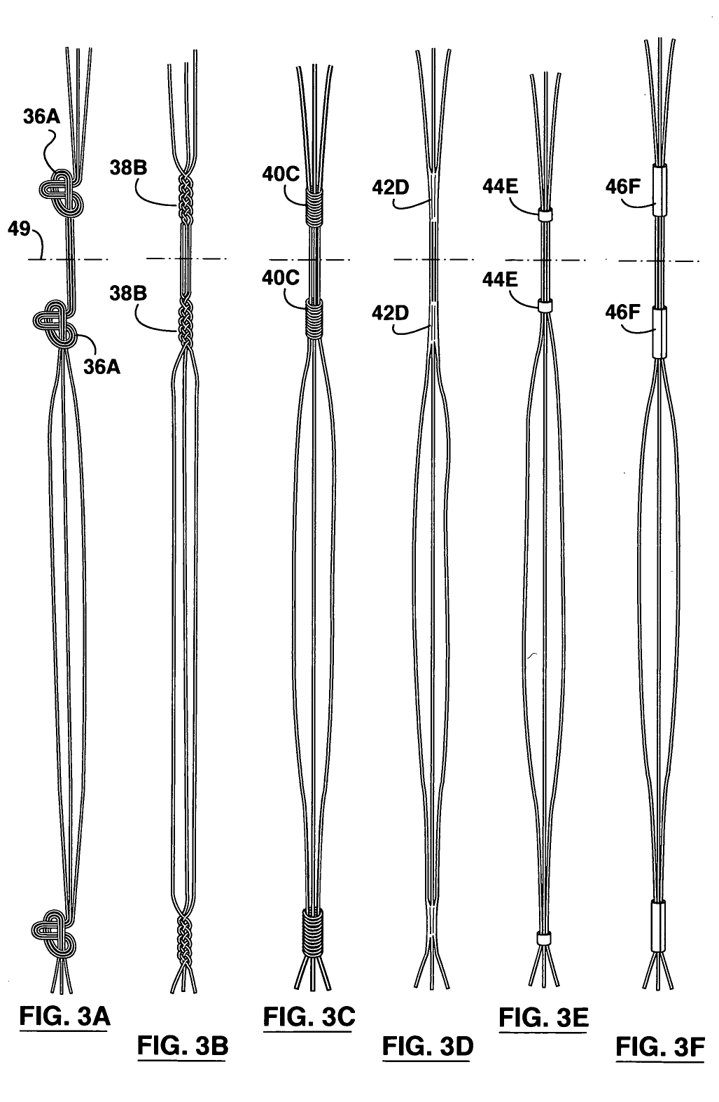

Referring to Bergman et al U.S. Pat. Application No. U.S. 2001/0029962 A1, and FIG. 3 thereof a binding tape for the multiple strands can comprise a relatively low strength, soft material such as fluorinated ethylene-propylene or polytetrafluoroethylene (PTFE), or high tensile material such as polypropylene. A brief application of heat will seal the strands together. Alternatively, an acrylic rapid cold setting adhesive can serve to bind the system.

The interconnection of strands 10B, 12B and 10D, 12D of FIGS. 1B and 1D as at 14B, 14D respectively are shown as cinched or conjoined by suitable clip ring formations.

It will be understood that the structures of dental floss segments of each of the FIGS. 1A, 1B, 1C and 1D lend themselves to automated manufacture or production by extruding same from suitable dies or drawing wound fibers from spools, for example, and conjoining same at intervals by adherence through suitable adhesive/heat sealing application compression equipment or by applying clip ring formations at selected intervals.

It will also be understood having regard to the aforesaid figures that the extended multiple stranded lengths manufactured or produced can be directly wound onto suitable spools or other repositories for enclosure within casings, containers or packages with embedded knife edges for distribution and sale, followed by the severing of selected lengths or segments by a user in the same manner of known dispensers for dental floss.

FIGS. 1A and 1B at broken lines 20, 22 respectively, signify where strands 10A, 12A, 10B, 12B segments can be cut or severed from an extended length of the dental floss agent.

Likewise, alternative FIGS. 1C and 1D show broken lines at 24, 26 respectively, signifying where in those embodiments the segments can be cut or severed from an extended length of the dental flossing agent.

It will be understood in relation to FIGS. 1C and 1D that the double conjoinder or cinching at 14C-14C and 14D-14D is repeated at selected intervals throughout the extended length of the dental floss agent in the preferred embodiment illustrated.

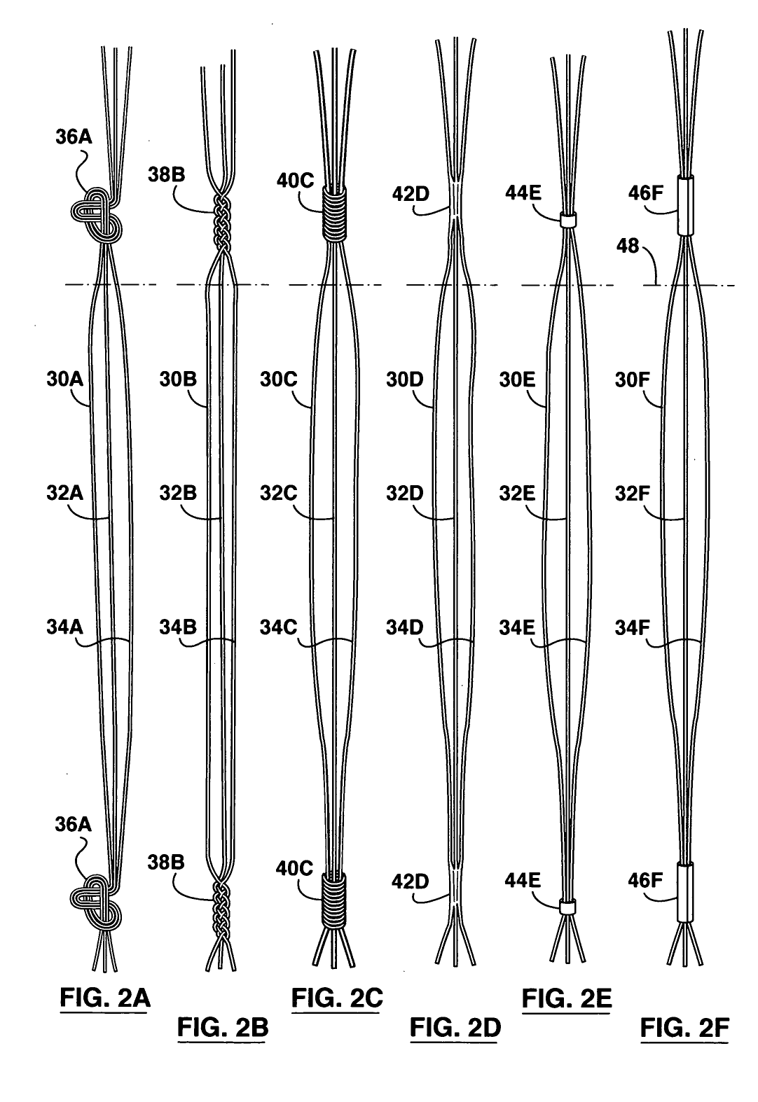

Turning to FIGS. 2A to 2F and 3A to 3F those embodiments illustrate how in accordance with the invention three strands or filaments can be conjoined or cinched at selected intervals.

FIG. 2A with the several strands 30A, 32A, 34A depicts the cinching or conjoinment of those strands in form of a knot 36A.

In FIG. 2B the several strands 30B, 32B and 34B are woven together at intervals as indicated at 38B.

Similarly in FIG. 2C the several strands 30C, 32C, 34C are cinched or conjoined by a coil derived from the same flossing strands as indicated at 40C, whereas in FIG. 2D strands 30D, 32D and 34D are shown as having been adhered or heat-sealed as at 42D together at the selected intervals.

FIG. 2E shows the strands 30E, 32E and 34E cinched by a selected ring 44E, whereas in FIG. 2F the strands 30F, 32F and 34F are shown cinched or conjoined by a suitable enclosing wrap 46F derived from sheet material either adhered to the strands or heat-sealed or applied in any other suitable manner.

FIGS. 3A to 3F inclusive compare to FIGS. 2A to 2F inclusive in the same manner as FIGS. 1A, 1B compare to FIGS. 1C and 1D as to the line of severance as at 48 in FIGS. 2A to 2F inclusive and as at 49 in FIGS. 3A to 3F inclusive.

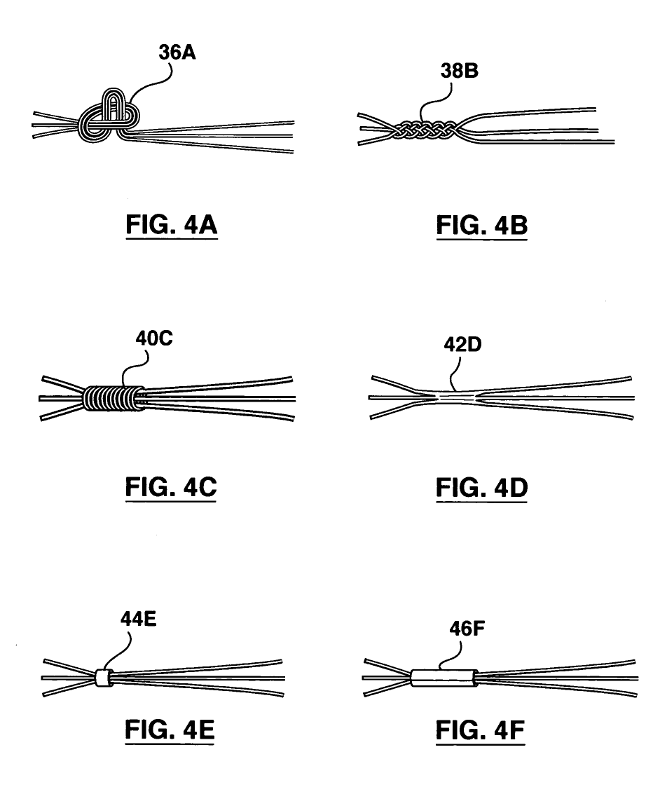

FIGS. 4A to 4F inclusive depict the cinching or conjoinment of the several strands of FIGS. 3A to 3F inclusive in the form of enlargements for greater clarity.

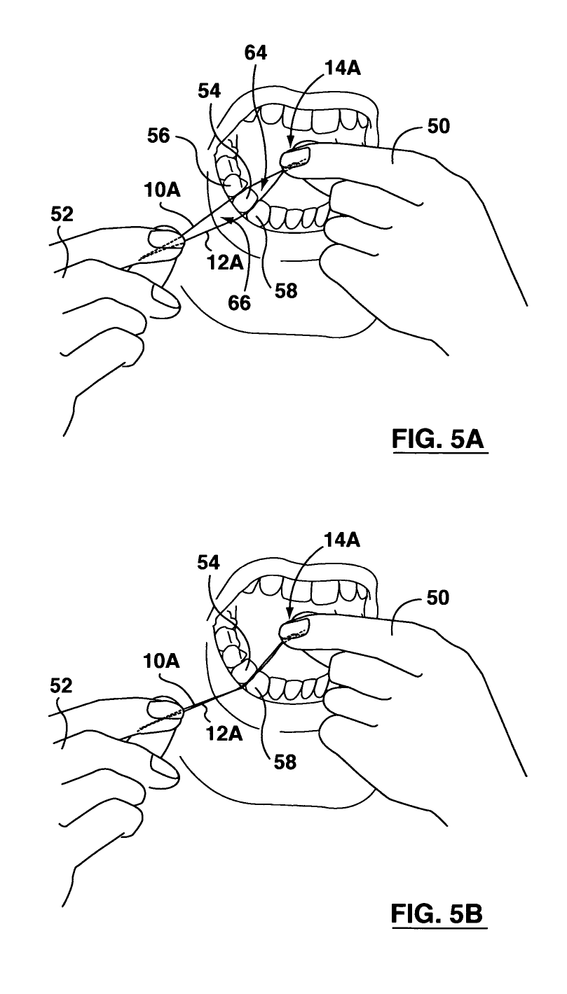

FIG. 5A is an illustration of how the two stranded flossing agents of FIGS. 1A to 1D inclusive can be manipulated using the embodiment of FIG. 1A.

With the fingers of the left hand 50 gripping the connection 14A therebetween designated by an arrow and with the fingers of the right hand 52 gripping the severed ends of the strands 10A, 12A therebetween, the separated strands 10A, 12A are entered into the opposed crevices of the tooth 54 between tooth 56 and 58 of the user's mouth.

In this manner with the strands 10A and 12A held taut by the fingers of the hands 50, 52 the two crevices can be fully entered and adjacent surfaces of the teeth engaged. This engagement under reciprocation by the fingers of the hands closely confines the opposed surfaces of tooth 54 within the loops or enclosures 64, 66 created by the tautly held strands 10A, 12A. These loops or enclosures reduce or diminish in one direction and expand in the other and create an increasingly compressive embracing engagement of the enclosed tooth 54 as the loops 64, 66 reduce or diminish and also abrade the flanking teeth to a lesser extent.

Alternatively, as shown in FIG. 5B is the insertion of strands 10A, 12A in a setting corresponding to FIG. 5A in one crevice only whereby the abrading action, cleaning action and removal action generated by reciprocation of the strands held tautly between the fingers of the hands 50, 52 will exert a clamping, dragging or seizing action on any debris including plaque and food particles, and so more efficiently perform the removal to be achieved with this improved flossing agent.

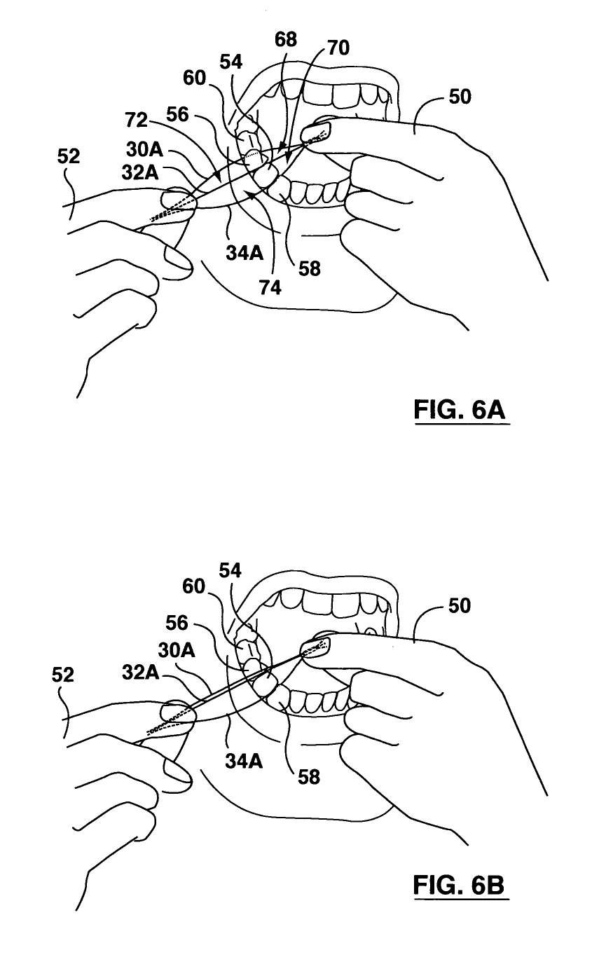

FIGS. 6A and 6B illustrate the manner of use of the embodiments of the invention illustrated in FIGS. 2A to 2F and 3A to 3F. The strands 30A, 32A, 34A of the embodiment of FIG. 2A are shown held taut between the cinched or conjoined end 36A and the free ends of the respective strands or between each cinched or conjoined end of the flossing agent depicted in FIG. 3A.

It will be observed in FIG. 6A that the strands 30A, 32A and 34A of the selected flossing agent of FIG. 2A are shown entered into the crevices between teeth 54, 56 and 58 and in addition into the crevice between teeth 56 and 60. So with the several strands tautly held between the fingers of the hands 50, 52 three crevices are engaged and forces exerted by the strands so held enclosing and conforming same to the surfaces of the teeth within the loops 68, 70, 72 and 74 so established and will perform, as earlier outlined, to accelerate removal of debris and polishing of the surfaces.

As in the case of the two-stranded flossing agent illustrated in FIG. 5A, the double loops 68, 70, 72 and 74 created by the arrangement of three strands in FIG. 6A shows the loops diminishing in one direction and then diminishing in the other direction upon reciprocation so that the abrading action is intensified in relation to the surfaces of the crevices to reach an improved standard of cleanliness.

FIG. 6B shows an alternative arrangement of strands 30A, 32A and 34A, wherein strands 30A, 32A enter the crevice between teeth 56, 60 and one strand 34A enters the crevice between teeth 54 and 58. Thus with strands 30A, 32A and through the reciprocation of the flossing agent by the user held between the fingers of the hands 50, 52 again a greater gripping or engaging force is exerted to embrace food particles therebetween and which strands have a more extensive lateral coverage of the opposed surfaces of the crevice.

It is emphasized that the forming of the loops of the several strands in taut reciprocation increases the abrasive and engaging forces applied to the teeth and debris as the loops diminish in either direction.

In still another application the flossing agent of any one of the preferred embodiments can be looped around a single tooth with the fingers outside the mouth so that the circumference of that tooth can be abraded over an extended surface area and the debris more certainly captured for removal.

As earlier indicated with the several stranded flossing agents of the embodiments illustrated and described, the selected strands can have properties that differ. For example one strand can be impregnated with disinfectant or a taste element or a teeth whitener and also include a strand having greater abrasive properties or provide combinations of impregnated or surface adhered components for the several strands.

Also as earlier indicated, suitable colouring can be applied to each strand and the flossing agents colour-coded so that users will be fully informed as to the results to be expected by selecting that particular flossing agent over others. Individual strands may be coloured by placing a suitable pigment, such as pthalocyanine green or diarylide yellow or the like in the polymer melt prior to extrusion of a monofilament.

It is also to be understood that in the illustrations of the several embodiments the views show enlargements of the conjoined ends and strands of the flossing agents for illustrative purposes only; whereas in commercial production and use the selected dimensions and cross-sections are within prescribed limits or tolerances.

It is intended that, where desired or necessary, the cinching or conjoinment as indicated at 36A, 38B, 40C, 42D, 44E, 46F where entered into a single crevice will give leverage or purchase to excise a particularly stubborn obstacle such as a plaque growth or food particle or seed.

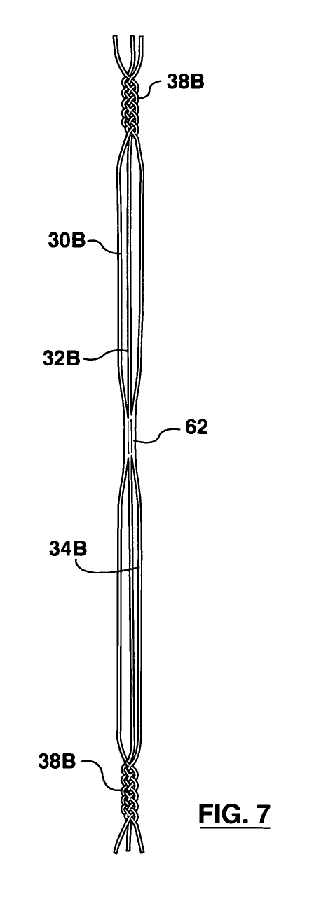

It is also an alternative as illustrated in FIG. 7 using the embodiment of FIG. 3B that conjoining same intermediately of the spaced apart ends of any one of the embodiments, as at 62 in FIG. 7, will routinely serve as a chisel-like or plow-like element to better ensure that the crevices are freed or cleared of debris to a much greater extent than with using the stranded combinations themselves.

While the preferred embodiments of the flossing agents their method of manufacture and uses have been illustrated and described persons skilled in this field may propose changes in structure or in the applications of them to flossing of teeth and in the manufacture or production of same without departing from the scope of the invention as defined by the appended claims.

1. In a dental flossing agent, at least a pair of suitable separated strands of a selected length for conjoinment at opposed ends and for insertion into one or more tooth crevices at the same time and which under taut reciprocation apply a dual abrading action to displace debris located therewithin for withdrawal.

2. A dental flossing agent according to claim 1 in which conjoinment at opposed ends is achieved by one or more of the following connections, namely clamped, heat sealed, adhered, knotted, woven, wrapped and of an extent sufficient for gripping same for reciprocation.

3. A dental flossing agent according to claims 1 or 2 in which at least two separated strands are so conjoined intermediately of the opposed ends as to establish an enlargement sufficient for exerting a displacement force against debris in the direction of the reciprocation.

4. A dental flossing agent according to claim 1 in which at least one separated strand has more than one property namely one of an abrasive quality and one or more of a pharmacological agent, flavouring agent and tooth whitener.

5. A dental flossing agent according to claim 4 in which one or more of the separated strands is colour coded to signify its added property.

6. In a method for flossing teeth the step of selecting more than one strand of a suitable flossing agent and arranging same in side by side relation, the step of conjoining the opposed ends thereof followed by the step of inserting one or more strands into one or more crevices between adjacent teeth and then tautly reciprocating same within the crevice or crevices.

7. In a method for the production of flossing agents the step of selecting more than one extended length of a strand of suitable flossing properties and arranging same in side by side relation followed by the step of conjoining the strands together at suitably spaced intervals therealong for ultimate severance therefrom of those segments extending between the conjoinments thereof.
